(19) United States
(12) Patent Application Publication
(10) Pub. No.: US 2022/0398559 A1
(43) Pub. Date: Dec. 15, 2022

(54) METHOD AND SYSTEM TO DETERMINE PAIRING MEMBERS IN A PEER TO PEER HEALTHCARE PAYMENT PLATFORM

(71) Applicant: M. L. Bose Memorial Health Foundation, Inc., Camillus, NY (US)

(72) Inventor: Ashoke Bose, Camillus, NY (US)

(73) Assignee: M. L. Bose Memorial Health Foundation, Inc., Camillus, NY (US)

(21) Appl. No.: 17/826,499

(22) Filed: May 27, 2022

Related U.S. Application Data
(60) Provisional application No. 63/209,968, filed on Jun. 12, 2021.

(51) Int. Cl. G06Q 20/22

(52) U.S. Cl. CPC G06Q 20/223

(57) ABSTRACT

A method performed by a peer to peer healthcare payment platform includes receiving a first amount of resources from one or more first donors in a first account associated with a first patient. The first account stores the first amount of resources and a second amount of surplus resources associated with the first patient. The method further includes receiving a payment request from the first patient. In response to receiving the payment request, the method includes determining if the outstanding medical fee associated with the first patient is greater than the sum of the first amount of resources and the second amount of surplus resources. If the outstanding medical fee is greater than said sum, the method includes identifying one or more second pairing patients for the first patient to fund the fee.

### CROSS REFERENCE TO RELATED APPLICATIONS

This application claims the benefit of priority to U.S. provisional patent application No. 63/209,968, filed on Jun. 12, 2021 and entitled A Method and System to Determine Pairing Members in a Peer to Peer Healthcare Payment Platform; the entirety of which is hereby incorporated by reference as if fully set forth herein.

### FIELD OF THE INVENTION

The present invention relates to a decentralized peer to peer (P2P) payment platform that allows members of the system to share the cost of their medical bills amongst themselves, without taking health insurance from commercial insurance providers. More specifically, the present invention relates to identification of one or more pairing members on the P2P payment platform, to share the load of paying medical bill(s) of a member who has insufficient funds to pay the bill(s). Further, the invention relates to a framework for making payment to healthcare service providers, such as hospitals, clinics, doctors and the like.

### BACKGROUND OF THE INVENTION

Around the world and specifically in the US, the cost of healthcare is increasing at an alarming rate. The primary reasons for the increase are the growth in the consumption of medical services and rapid technological innovation. Specifically in the US, doctors and health prescribers are prescribing more medical tests these days. Also, patients too are using more and more medical services, as they know that their medical expenditure is covered by medical insurance. This has led to considerable increase in healthcare expenditure.

In order to compensate for the rising healthcare cost, the insurance providers are continuously increasing medical insurance premium. This has led to a considerable burden on the members who utilize the services of these insurance providers.

Typically, the medical insurance premium is internally divided by the insurance providers into three main components, 1) Expected cost of the health benefits covered under the plan, 2) Administrative cost of operating the plan, and 3) Profit. In the US, the Affordable Care Act (ACA) imposed an upper limit on the administrative cost as a percentage of the total medical insurance premium collected from the members. However, since the cost of the medical insurance premium is increasing, the administrative cost is also increasing simultaneously. In general, the administrative cost in health insurance is high due to multiple health plans, monitoring, enforcement of mandate and general business administration expenses.

There is a need for a method and system that allows elimination of the administrative cost of the conventional healthcare insurance system, leading to lesser burden on the members who use medical services.

### SUMMARY OF THE INVENTION

The present invention is directed towards a method performed by a peer to peer healthcare payment platform. The method includes receiving a first amount of resources from one or more first donors, of a plurality of donors, in a first account associated with a first patient of the plurality of patients. The first account stores the first amount of resources and a second amount of surplus resources associated with the first patient. The plurality of donors and the plurality of patients are associated with the peer to peer healthcare payment platform, and the peer to peer healthcare payment platform is configured to manage the accounts of each of the plurality of patients. The method further includes receiving a payment request from the first patient. The payment request includes an outstanding medical fee, payment due date, and details of the one or more medical service providers associated with the outstanding medical fee. In response to receiving the payment request, the method includes determining if the outstanding medical fee of the one or more medical service providers is greater than the sum of the first amount of resources and the second amount of surplus resources. In response to a determination that the outstanding medical fee is greater than the sum of the first amount of resources and the second amount of surplus resources, the method includes estimating medical benefit expenses of each of the plurality of patients based on a plurality of parameters. The plurality of parameters comprises historical medical expenses, health history, outstanding medical fee, and age. The method further includes identifying one or more second pairing patients, from the plurality of patients, for the first patient based on the estimation of the medical benefit expenses. The one or more second pairing patients are identified such that an average estimated medical benefit expense of the first patient and the one or more second pairing patients is equal to a target medical benefit expense. The method further includes receiving a third amount of resources from a second account of the one or more second pairing patients in the first account. The third amount of resources is equal to the difference between the outstanding medical fee and the sum of the first amount of resources and the second amount of surplus resources. The method further includes disbursing the outstanding medical fees to a third account associated with the one or more medical service providers from the first account. The disbursement is performed using the first amount of resources, the second amount of surplus resources, and the third amount of resources.

In accordance with an embodiment of the present invention, the plurality of donors includes one or more of employers, Government Organizations, healthcare or public welfare foundations, Non-Governmental Organizations (NGOs), clients or customers, parents, and individuals.

In accordance with an embodiment of the present invention, the plurality of donors comprises one or more patients of the plurality of patients. In other words, a few patients of the peer to peer healthcare payment platform can also be donors to other patients of the platform.

In accordance with an embodiment of the present invention, the method further includes determining if the outstanding medical fee is less than the first amount of resources, and in response to a determination that the outstanding medical fee is less than the first amount of resources, disbursing the outstanding medical fee to the third account from the first account. The disbursement is performed using the first amount of resources. The method further includes storing a surplus amount of resources as the second amount of surplus resources in the first account based on a determination that the outstanding medical fee is less than the first amount of resources. The surplus amount of resources is the difference between the outstanding medical fee and the first amount of resources.

In accordance with an embodiment of the present invention, the method further includes determining if the outstanding medical fee is greater than the first amount of resources but less than the sum of the first amount of resources and the second amount of surplus resources. In response to a determination that the outstanding medical fee is greater than the first amount of resources but less than the sum of the first amount of resources and the second amount of surplus resources, disbursing the outstanding medical fee to the third account from the first account. The disbursement is performed using the first amount of resources and the second amount of surplus resources.

In accordance with an embodiment of the present invention, the target medical benefit expense is set by the peer to peer healthcare payment platform.

In accordance with an embodiment of the present invention, the first amount of resources is received in the first account at a periodic frequency, for example monthly or quarterly, and the like.

The present invention is further directed towards a peer to peer healthcare payment platform, the peer to peer healthcare payment platform includes a receiver that is configured to receive a first amount of resources from one or more first donors, of a plurality of donors, in a first account associated with a first patient of the plurality of patients. The first account stores the first amount of resources and a second amount of surplus resources associated with the first patient. The plurality of donors and the plurality of patients are associated with the peer to peer healthcare payment platform, and the peer to peer healthcare payment platform is configured to manage accounts of each of the plurality of patients. The receiver is further configured to receive a payment request from the first patient. The payment request comprises outstanding medical fee, payment due date, details of the one or more medical service providers associated with the outstanding medical fee. The peer to peer healthcare payment platform further includes a processor that is configured to determine, in response to receiving the payment request, if the outstanding medical fee of the one or more medical service providers is greater than the sum of the first amount of resources and the second amount of surplus resources. The processor is further configured to estimate medical benefit expenses of each of the plurality of patients based on a plurality of parameters, in response to a determination that the outstanding medical fee is greater than the sum of the first amount of resources and the second amount of surplus resources. The plurality of parameters comprises historical medical expenses, health history, outstanding medical fees, and age. The processor is further configured to identify one or more second pairing patients, from the plurality of patients, for the first patient based on the estimation of the medical benefit expenses. The one or more second pairing patients are identified such that an average estimated medical benefit expense of the first patient and the one or more second pairing patients is equal to a target medical benefit expense. The receiver is further configured to receive a third amount of resources from a second account of the one or more second pairing patients in the first account. The third amount of resources is equal to the difference between the outstanding medical fee and the sum of the first amount of resources and the second amount of surplus resources. The peer to peer healthcare payment platform further includes a payment unit that is configured to disburse the outstanding medical fees to a third account associated with the one or more medical service providers from the first account. The disbursement is performed using the first amount of resources, the second amount of surplus resources, and the third amount of resources.

In accordance with an embodiment of the present invention, the plurality of donors includes one or more of employers, Government Organizations, healthcare or public welfare foundations, Non-Governmental Organizations (NGOs), clients or customers, parents, and individuals.

In accordance with an embodiment of the present invention, the plurality of donors includes one or more patients of the plurality of patients.

In accordance with an embodiment of the present invention, the processor is further configured to determine if the outstanding medical fee is less than the first amount of resources, and the payment unit is further configured to disburse, in response to a determination that the outstanding medical fee is less than the first amount of resources, the outstanding medical fee to the third account from the first account. The disbursement is performed using the first amount of resources. The payment unit is further configured to store a surplus amount of resources as the second amount of surplus resources in the first account based on a determination that the outstanding medical fee is less than the first amount of resources. The surplus amount of resources comprises the difference between the outstanding medical fee and the first amount of resources.

In accordance with an embodiment of the present invention, the processor is further configured to determine if the outstanding medical fee is greater than the first amount of resources but less than the sum of the first amount of resources and the second amount of surplus resources, and the payment unit is further configured to disburse, based on a determination that the outstanding medical fee is greater than the first amount of resources but less than the sum of the first amount of resources and the second amount of surplus resources, the outstanding medical fee to the third account from the first account. The disbursement is performed using the first amount of resources and the second amount of surplus resources.

In accordance with an embodiment of the present invention, the target medical benefit expense is set by the peer to peer healthcare payment platform.

In accordance with an embodiment of the present invention, the first amount of resources is received in the first account at a periodic frequency.

The present invention is directed towards a non-transitory computer readable medium comprising instructions, that when executed by a processor in a peer to peer healthcare payment platform, cause the processor to perform receiving a first amount of resources from one or more first donors, of a plurality of donors, in a first account associated with a first patient of the plurality of patients. The first account stores the first amount of resources and a second amount of surplus resources associated with the first patient. The plurality of donors and the plurality of patients are associated with the peer to peer healthcare payment platform. The peer to peer healthcare payment platform is configured to manage accounts of each of the plurality of patients. The non-transitory computer readable medium comprising instructions, that when executed by a processor, cause the processor to further perform receiving a payment request from the first patient. The payment request includes an outstanding medical fee, payment due date, and details of the one or more medical service providers associated with the outstanding medical fee. The non-transitory computer readable medium comprising instructions, that when executed by a processor, cause the processor to further perform determining, in response to receiving the payment request, if the outstanding medical fee of the one or more medical service providers is greater than the sum of the first amount of resources and the second amount of surplus resources. In response to a determination that the outstanding medical fee is greater than the sum of the first amount of resources and the second amount of surplus resources, The non-transitory computer readable medium comprising instructions, that when executed by a processor, cause the processor to further perform estimating medical benefit expenses of each of the plurality of patients based on a plurality of parameters. The plurality of parameters includes historical medical expenses, health history, outstanding medical fees, and age. The non-transitory computer readable medium comprising instructions, that when executed by a processor, cause the processor to further perform identifying one or more second pairing patients, from the plurality of patients, for the first patient based on the estimation of the medical benefit expenses. The one or more second pairing patients are identified such that an average estimated medical benefit expense of the first patient and the one or more second pairing patients is equal to a target medical benefit expense. The non-transitory computer readable medium comprising instructions, that when executed by a processor, cause the processor to further perform receiving a third amount of resources from a second account of the one or more second pairing patients in the first account. The third amount of resources is equal to the difference between the outstanding medical fee and the sum of the first amount of resources and the second amount of surplus resources. The non-transitory computer readable medium comprising instructions, that when executed by a processor, cause the processor to further perform disbursing the outstanding medical fee to a third account associated with the one or more medical service providers from the first account. The disbursement is performed using the first amount of resources, the second amount of surplus resources, and the third amount of resources.

### BRIEF DESCRIPTION OF THE DRAWINGS

FIG. 1 shows a conventional centralized system.

FIGS. 2a and 2b show a conventional healthcare insurance system.

FIG. 3 shows a decentralized peer to peer (P2P) healthcare payment platform, in accordance with an embodiment of the present invention.

FIG. 4 shows a diagram illustrating relationship between members of the P2P platform, in accordance with an embodiment of the present invention.

FIG. 5 shows a geometrical representation for identification of one or more pairing members, in accordance with an embodiment of the present invention.

FIGS. 6a and 6b show a distribution of Medical Benefit Expense (MBE) of patients, in accordance with an embodiment of the present invention.

FIGS. 7a-7e illustrate different embodiments of transferring outstanding medical service fee to a medical service provider.

FIG. 8 shows a flowchart illustrating a method for making payment to the medical service providers, in accordance with an embodiment of the present invention.

FIG. 9 illustrates a system for making payment to the medical service providers, in accordance with an embodiment of the present invention.

### DETAILED DESCRIPTION

Hereinafter, the preferred embodiments of the present disclosure will be described in conjunction with the accompanying drawings. It should be understood that the preferred embodiments described herein are only used to illustrate and explain the present disclosure and are not intended to limit the present disclosure.

The following description includes the preferred best mode of one embodiment of the present invention. It will be clear from this description of the invention that the invention is not limited to these illustrated embodiments but that the invention also includes a variety of modifications and embodiments thereto. Therefore, the present description should be seen as illustrative and not limiting. While the invention is susceptible to various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

In any embodiment described herein, the open-ended terms “comprising”, “comprises”, and the like (which are synonymous with “including”, “having” and “characterized by”) may be replaced by the respective partially closed phrases “consisting essentially of”, “consists essentially of”, and the like or the respective closed phrases “consisting of”, “consists of”, the like.

As used herein, the singular forms “a”, “an”, and “the” designate both the singular and the plural, unless expressly stated to designate the singular only.

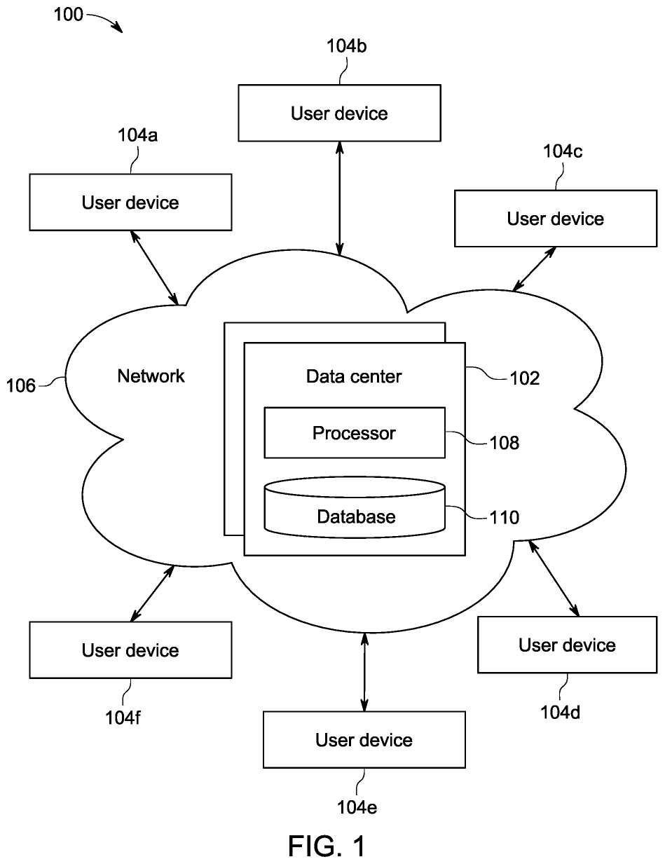

FIG. 1 shows a conventional centralized system 100. The centralized system 100 may include a datacenter 102 that is communicatively coupled to user devices 104a-104f (collectively considered as user device 104), via a network 106. The network 106 may be the internet, intranet, a local area network (LAN), a wide area network (WAN), wireless LAN (WLAN), wireless fidelity (Wi-Fi), and similar networks.

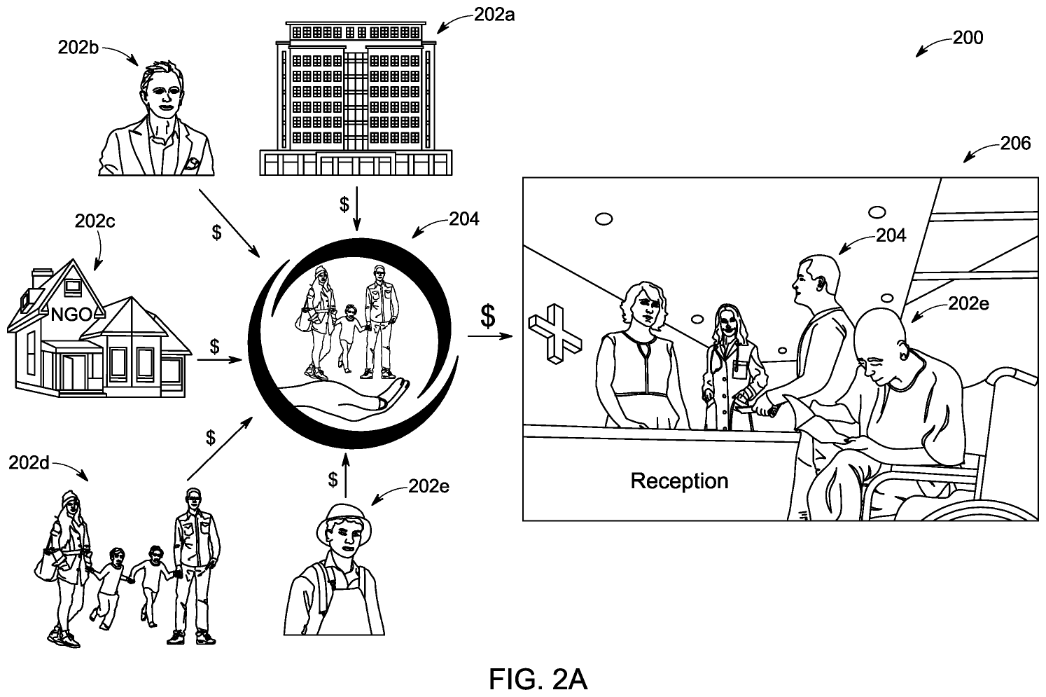

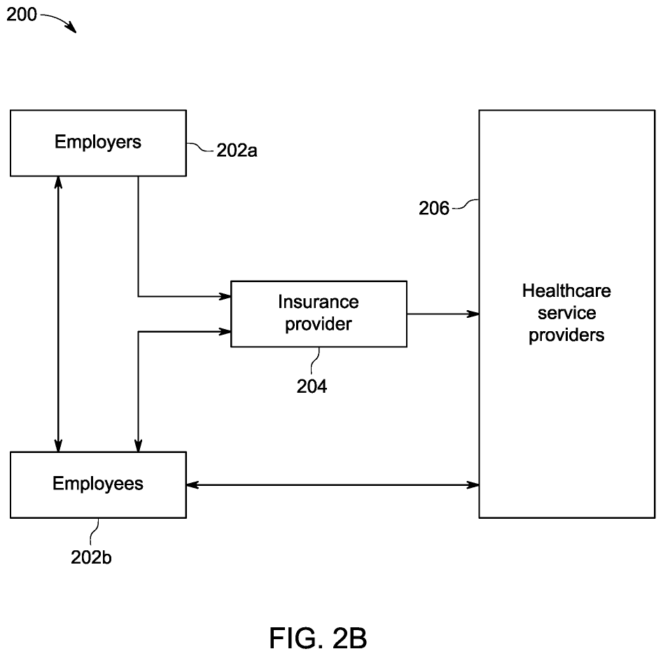

A user (not shown in FIG. 1) may use the user device 104 to connect with the datacenter 102, via the network 106, to avail healthcare/medical services from medical insurance companies that may themselves be connected to the datacenter 102. In essence, the datacenter 102 may be a centralized server that may enable one or more users to connect with one or more medical insurance companies to avail their services. For instance, the user may connect with the datacenter 102 to obtain health insurance from an insurance company by paying a specific insurance premium on a regular basis. In return, the insurance company may cover the whole or a portion of the risk of the user incurring medical expenses. The details of the conventional healthcare insurance system may be understood in conjunction with FIG. 2a.

The datacenter 102 may be a server owned by one or more insurance companies, or may be a third party server that is used by one or more insurance companies to provide their services to users.

The datacenter 102 may include computing hardware and software that may host various applications to perform different tasks. The datacenter 102 may include one or more processors 108 and one or more databases 110, which may be communicably connected to a memory (not shown separately in FIG. 1) of the datacenter 102. The datacenter 102 may include one or more other components which are not described in FIG. 1. The one or more processors 108 may include one or more microprocessors, microcontrollers, digital signal processors (DSPs), state machines, logic circuitry, or any other device or devices that process information based on operational or programming instructions. Such operational or programming instructions may be stored in the memory of the datacenter 102. One of ordinary skill in the art will recognize that when the one or more processors 108 has one or more of its functions performed by a state machine or logic circuitry, the memory containing the corresponding operational instructions can be embedded within the state machine or logic circuitry. The memory may be an integrated circuit (IC) memory chip containing any form of random-access memory (RAM) or read-only memory (ROM), a floppy disk, a compact disk read-only memory (CD-ROM), a hard disk drive, a digital video disc (DVD), a flash memory card, external subscriber identity module (SIM) card or any other medium for storing non-transitory digital information.

The user device 104 may be a communication device, such as a mobile phone, a smart phone, a mobile node, a smart watch, a personal digital assistant (PDA), a tablet computer, a laptop computer, or the like with communication capabilities.

FIG. 2a shows a conventional healthcare insurance system 200 that includes, but is not limited to, employers 202a, employees 202b, government/Non-Government Organizations (NGOs)/healthcare or public welfare foundations 202c, families 202d, and individuals 202e (collectively shown as members 202). The members 202 pay respective medical insurance premium to an insurance provider 204, and in exchange, transfer risk to the insurance provider 204 and enjoy the benefits of medical services provided by medical service providers 206. The insurance premiums may be decided based on a number of parameters such as age, health history, family history, and the like. The medical service fee of the medical service providers 206 are directly handled by the insurance provider 204. The medical service fee, to be paid by the insurance provider 204, may be greater or lesser than the medical insurance premium paid by the members 202. So, in a way, the members 202 transfer their risk to the insurance provider 204.

FIG. 2b shows an embodiment of the conventional healthcare insurance system 200. Typically, the employers 202a pay specific amount to the employees 202b, in exchange of the services provided by the employees 202b. The amount may include, for example, the salaries paid by the employers 202a to the employees 202b. In addition, the employers 202a may also pay a part of the medical insurance premium to the insurance provider 204, on behalf of the employees 202b. In addition, the employees 202b may themselves pay a part of the medical insurance premium to the insurance provider 204, to transfer risk to the insurance provider 204 and avail the benefit of the medical services provided by the medical service providers 206, as described above. In other words, the insurance provider 204 may receive money from the employers 202a and the employees 202b, and transfers some part of the money to the respective medical service providers 206 for the medical services availed by the employees 202b. In some cases, the employees 202b may also give the medical service fee directly to the medical service providers 206 to avail the medical services, and may later reimburse the medical bill from the insurance provider 204.

As can be understood by a person ordinarily skilled in the art, FIG. 2b is just an illustration of the conventional healthcare system 200. There are other means as well through which the insurance provider 204 may receive medical insurance premium from the individuals 202d or even the employees 202b. Examples of such means may include, but are not limited to, medical insurance premium paid directly by government, NGOs, healthcare or public welfare foundations (collectively shown as 202c in FIG. 2a).

Further, as shown in FIG. 1, the members 202 may use a centralized datacenter/server to pay insurance premiums to the insurance provider 204. The insurance provider 204 may use the same or a different datacenter/server to pay the incurred medical fees to the medical service providers 206.

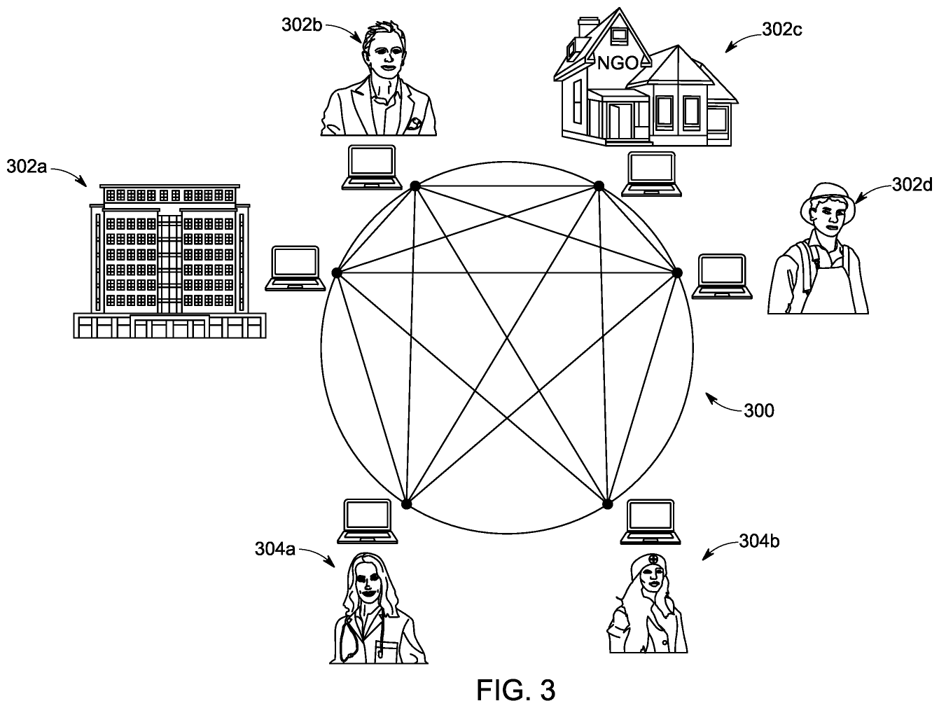

As the cost of healthcare is increasing, the amount of medical insurance premium to be paid to the insurance provider 204 is also increasing. In order to avoid paying the huge premium and save money of patients, the present invention proposes a decentralized peer-to-peer (P2P) healthcare payment platform 300, as shown in FIG. 3.

FIG. 3 shows the decentralized P2P healthcare payment platform 300 (hereinafter referred to as P2P platform 300) in accordance with an embodiment of the present invention. In the P2P platform 300, there is no reliance on a centralized datacenter or a network operator. Also, there is no insurance provider, and the members of the P2P platform 300 directly interact with medical service providers 206, without involving any third-party commercial insurance provider. Also, the P2P platform 300 includes decentralized applications that operate over P2P network 300, without any third party involvement. Since no third party is involved (i.e. no insurance provider), the “administrative” or “business” or “operational” charges levied by the insurance providers in the medical insurance premium are eliminated. This way, the P2P platform 300 provides an advantage of reducing administrative cost in the medical insurance premium, and thus reducing the overall medical insurance premium that is to be paid by the members of the P2P platform 300. In addition, the P2P platform 300 facilitates fundraising process, and maintains transparency and accuracy of funds that are visible to all the members of the P2P platform 300.

A person ordinarily skilled in the art can appreciate that the P2P platform 300 may include various computing devices/resources that are used by the members of the P2P platform 300 to connect with each other, and with the medical service providers 206. Said computing devices may include server computers, database servers, computing nodes, and any other computing devices including memory, storage devices, processors and the like. The above-mentioned computing devices are connected by a network (not shown in FIG. 3), and are accessible to all the members of the P2P platform 300. In an embodiment, the computing devices may operate in concert on the P2P platform 300. In another embodiment, the processors of the computing devices may execute network protocols to create the P2P platform 300, and perform its functions. A person ordinarily skilled in the art may appreciate that in a P2P network, the participant computing devices share a part of their hardware resources (e.g. processing power, storage capacity, etc.) to provide service and content (e.g. file sharing, shared workspace, etc.) offered by the P2P network. These services and content are accessible to all the participant computing devices. Therefore, the participant computing devices are both resource providers and resource requesters.

In accordance with an embodiment of the present invention, FIG. 3 illustrates the P2P platform 300 that may include computing devices associated with entities such as employers 302a, employees 302b, government/NGOs/healthcare or public welfare foundations 302c, and individuals/families 302d. These entities are collectively termed as members 302 of the P2P platform 300. As shown in FIG. 3, the P2P platform 300 may be created by using the computing devices of the members 302 of the P2P platform 300, and all the computing devices of the P2P platform 300 may be directly connected with each other, thus forming a decentralized P2P healthcare payment system/platform. Further, the computing devices of the members 302 may be directly connected with the computing devices of medical service providers 304a, 304b. In accordance with an embodiment of the present invention, the computing devices of the medical service providers 304a, 304b may themselves be a part of the P2P platform 300. In accordance with another embodiment of the present invention, the computing devices of the medical service providers 304a, 304b may not be a part of the P2P platform 300. In other words, the present invention can work efficiently, irrespective of whether the computing devices associated with the medical service providers 304a, 304b are a part of the P2P network 300 or not.

According to the present invention, the members 302 of the P2P network 300 share their medical risks amongst themselves instead of transferring the medical risks to a centralized conventional healthcare insurance system, like the conventional healthcare insurance system 200 shown in FIG. 2a. In particular, the present invention proposes a solution to eliminate the administrative cost of the conventional healthcare insurance system 200. The details of the process of transferring the risks amongst the members of the P2P platform 300 may be understood in conjunction with the subsequent figures.

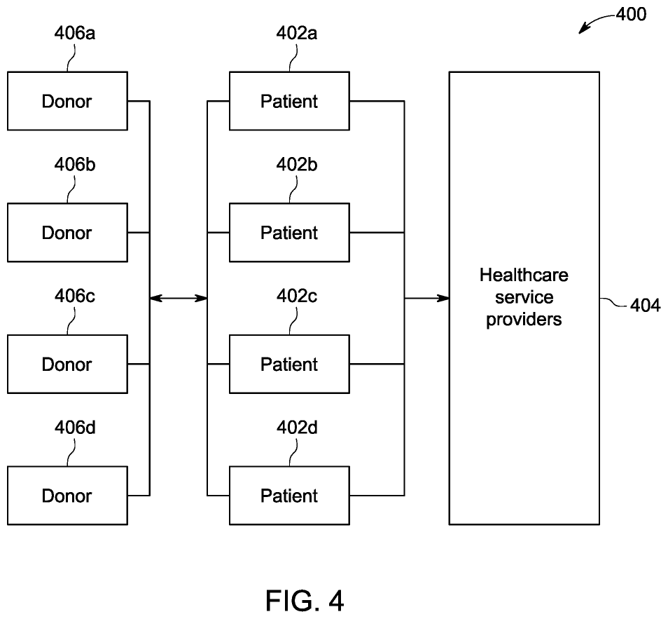

FIG. 4 shows a diagram 400 illustrating relationship between the members of the P2P platform 300, in accordance with an embodiment of the present invention. As shown in FIG. 4, the P2P platform 300 may include a set of patients 402a, 402b, 402c, 402d (collectively referred to as a set of patients 402) who use medical services offered by hospitals, clinics, doctors, nurses and the like (collectively shown as medical service providers 404 or healthcare service providers 404). The set of patients 402 includes, but is not limited to, users that use medical services for their routine checkup or for specific treatment of a disease such as diabetes, heart problems, emergency conditions, and the like. In an embodiment, the set of patients 402 may include employees 302b. In another embodiment, the set of patients 402 may include owner/director of a company or firm, self-employed person, a student, and the like. The offered medical services may include, but are not limited to, consultancy of a doctor to a patient, support provided by nurses, treatment resources, medication, and the like. The set of patients 402 may have different levels of medical risks, which may be based on their age, medical history, family history, lifestyle, current medical conditions, and the like.

The P2P platform 300 further includes a set of donors 406a, 406b, 406c, and 406d (collectively referred to as set of donors 406), who provide a predetermined amount of resources (e.g. money) to the respective or specific patients of the set of patients 402. In accordance with an embodiment of the invention, the set of donors 406 and the set of patients 402 are a part of the members of the P2P network 300, as shown in FIG. 3.

The set of donors 406 may transfer the resources to the accounts associated the corresponding set of patients 402. In an embodiment of the invention, each patient of the set of patients 402 has an individual account managed by the P2P platform 300. Further, each donor of the set of donors 406 has an individual account that may be managed by the P2P platform 300. In other words, the accounts associated with the set of patients 402 and the set of donors 406 may be accessible or may be operated by one or more computing devices that form the P2P platform 300. In particular, the P2P platform 300 may enable the plurality of patients and the plurality of donors to create their accounts on the P2P platform 300. After this, the P2P platform 300 may be configured to transfer resources from donor's account to the patient's account, and also configured to receive resources in patient's account from donor's account.

The set of donors 406 may include, but are not limited to, employers, government organizations, healthcare or public welfare foundations, Non-Governmental Organizations (NGOs), clients/customers, parents, individuals, and the like. In an embodiment of the invention, the set of patients 402 and the set of donors 406 are mutually exclusive. In other words, if a person is a part of the set of patients 402, then that person may not be a part of the set of donors 406. In another embodiment of the invention, the set of patients 402 and the set of donors 406 are not mutually exclusive, and the set of donors 406 may include one or more patients of the set of patients 402. In other words, if a person is a part of the set of patients 402, then that person may be a part of the set of donors 406 as well, and is allowed to transfer resources to another patient of the set of patients 402. In addition, the P2P platform 300 may be configured to transfer resources from one patient's account to another patient's account, and also configured to receive resources in the patient's account from the other patient's account.

In an embodiment of the present invention, one or more of the set of donors 406 may transfer a first amount of resources (e.g. money) at a regular or periodic frequency from their accounts to the accounts of the respective or specific patients of the set of patients 402. The first amount of resources may be added to the accounts of the respective or specific patients of the set of patients 402 present on the P2P platform 300. In other words, the P2P platform 300 may be configured to receive the first amount of resources from the one or more donors of the set of donors 406 in the accounts of the respective or specific patients. The frequency of the transfer of (or receiving of) the first amount of resources may be monthly, quarterly, yearly, or any other frequency. In another embodiment of the present invention, a donor from the set of donors 406 may only transfer/pay once, or may transfer/pay at irregular intervals based on the requirements of the respective or specific patients of the set of patients 402.

The first amount of resources may be predetermined and may include, but is not limited to, monthly salary or a part thereof from an employer, donations from NGOs or healthcare or public welfare foundations, donation from any individual, service/professional fee from the customers/clients in return of the services provided to the customers/clients, money from parents, and the like. In accordance with further embodiment of the present invention, the first amount of resources may vary from patient to patient based on various parameters such as, but not limited to, medical expenditure of a patient, age, total salary, medical history, financial capability, location of residence, employment tenure of the patient, services provided to clients/customers, and the like.

In an embodiment of the present invention, the first amount of resources transferred/paid by each donor of the set of donors 406 may be different. Also, the amount of resources received by each patient of the set of patients 402 may be different. In other words, the amount of resources received by one patient from a donor may be different from the amount of resources received by another patient from the same or a different donor on the P2P platform 300.

In another embodiment of the present invention, the amount of resources received by whole or a part of the set of patients 402 is the same. Also, the amount of resources paid by the one or more donors of the set of donors 406 is the same.

Further, the set of patients 402 may send a request to the P2P platform 300 to transfer medical service fees from their accounts on the P2P platform 300 to the accounts respective medical service providers 404. In other words, the medical service fee is directly paid to the medical service providers 404 by the respective set of patients 402, which is in contrast to the conventional healthcare insurance system 200 where the insurance provider 204 pays the medical service fee. In accordance with another embodiment of the present invention, the request to transfer the medical service fee from patients' account may be sent by any other person (including the respective medical service providers 404), and may be approved by the respective patient.

The medical service fee may be paid, for example, when one or more patients from the set of patients 402 avail the medical services offered by the medical service providers 404. The medical service fee to the healthcare service providers 404 may be paid one time, or may be paid periodically such as monthly, quarterly, yearly. In an embodiment of the present invention, each medical service provider of the medical service providers 404 needs to submit an invoice or a bill of the medical services to the P2P platform 300 or directly to the respective patients of the set of patients 402 to claim the medical service fee.

As can be understood by a person ordinarily skilled in the art, the medical service fee may vary from one medical service provider to another, and may also vary based on the medical services availed by each patient of the set of patients 402. In other words, the medical service fee received by one medical service provider may be different from the medical service fee received by another medical service provider. In another embodiment of the present invention, the medical service fee received by whole or a part of the medical service providers 404 is the same. The medical service fee may include, but is not limited to, consultancy of a doctor to a patient, support provided by nurses, treatment resources, medication, and the like. Also, as discussed above, the medical services received by a patient and another patient may be different due to the medical conditions, age, lifestyle, and the like.

As mentioned above in conjunction with FIG. 4, the medical service fee may be directly paid to the medical service providers 404 by the respective set of patients 402 of the P2P platform 300. A person ordinarily skilled in the art may understand that at times, the medical service fee that is to be paid by a patient (Patient ‘X’), may be more than the money that might be available on his account on the P2P platform 300. In this case, the Patient ‘X’ will seek funds from other patients in the P2P platform 300 to pay his medical service fee (“outstanding medical fees”). The present invention proposes a method to identify such a person (pairing patient) who can provide funds to the Patient ‘X’. The details of the method for identification of the donor may be understood in conjunction with subsequent figures.

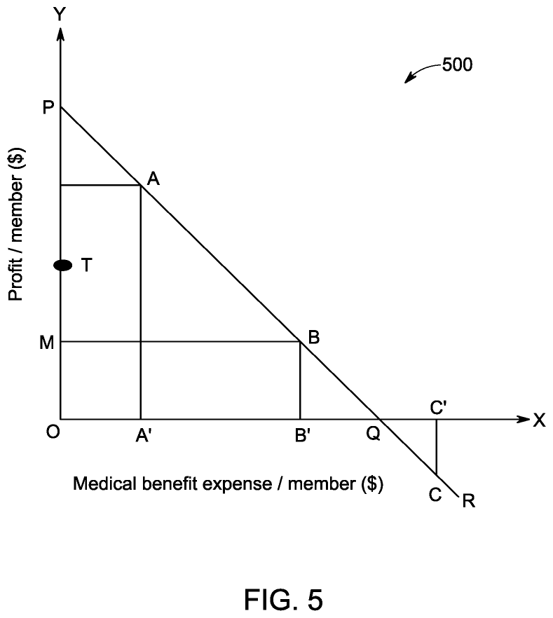

FIG. 5 shows a geometrical representation 500 for identification of one or more pairing members, in accordance with an embodiment of the present invention. To explain the process of identification of one or more pairing members, a brief description of conventional healthcare insurance system 200 will also be provided and used.

To understand the representation, consider a member A (or patient A) who is a teenager with no medical history and hence incurs substantially less medical benefit expense (in other words, member A's medical expenses are less). Another member B (or patient B) may be considered who is suffering from diabetes, and thus incurs a higher medical benefit expense. In accordance with an embodiment of the present invention, the medical benefit expense may be the medical service fee.

As can be understood by a person ordinarily skilled in the art, in the conventional healthcare insurance system 200, the medical insurance premium paid by the members 202, including member A and member B, and their respective employer(s) is the same. Since the medical benefit expenses of these two members are different, it is understood that the profit earned by the insurance provider 204 from the member A and the member B may be different.

Also, it is to be noted that in the conventional healthcare insurance system 200, the insurance provider 204 does not inject any amount into the system by itself. Thus, the following relation may be derived:

F3(A)+P(A)=F3(B)+P(B)=Constant Eq. (1)

In Eq. (1), F3(A) is the medical benefit expense for the member A;
P(A) is profit generated from the member A;
F3(B) is the medical benefit expense for the member B; and
P(B) is profit generated from the member B

This suggests that the sum of the medical benefit expense of the member A and the profit generated from the member A is the same as the sum of the medical benefit expense of the member B and the profit generated from the member B, and is equal to a constant.

Thus, it may be derived that the medical benefit expense of the member A and the profit generated from the member A is also constant. In other words, the following relation may be derived:

F3(A)+P(A)=Constant=(1+EWR(A))*F2(A)−{(O(A)+M(A))} Eq. (2)

Where

EWR(A)=Employer Worker Ratio=F1(A)/F2(A) Eq. (3)

F1(A) is the medical insurance premium payment by donor (such as employer) of the member A,
F2(A) is the medical insurance premium paid by the member A himself/herself (such as employee)
O(A) is operational cost of the member A in the conventional healthcare insurance system, and
M(A) is marketing cost of the member A in the conventional healthcare insurance system 200.

The Equation (1) is an important relation between profit per member and medical benefit expense (MBE) per member. The Equation (1) forms the basis of the present invention.

Based on equation (1), it may be derived that for every member A (or patient A), there exists a “pairing” member (i.e. member B/patient B), who will allow the combined profit derived from both members A and B to be equal to any “feasible” target profit per member.

To explain the concept of “feasible” profit and “feasible” target profit per member, taking FIG. 4 as a reference, it is assumed that the X-axis (horizontal axis) represents MBE per member. Further, Y-axis (vertical axis) represents profit generated per member. Thus, OP represents maximum profit per member, P(MAX). OQ represents the amount of MBE at which the profit per member becomes zero. If the MBE of a member becomes greater than OQ, then the insurance provider 106 encounters financial loss from that member. Any point on segment OP represents feasible profit per member. The straight line PQR represents the Equation 1.

For the sake of the explanation of the graph 400, it is assumed that there are three members A, B, and C who incur medical benefit expenses. Thus, the geometrical representation indicates:

AA′, which is the profit generated from the member A;
BB′, which is the profit generated from the member B;
CC′, which is the loss generated from the member C;
OA′ represents the MBE of the member A;
OB′ represents the MBE of the member B; and
OC′ represents the MBE of the member C.

As derived from equation (1), OA′+AA′=OB′+BB′=constant. It may be further derived that OP=OQ.

In an embodiment of the present invention, ‘T’ represents a feasible target profit, which may be defined/set by the P2P network 300. T could lie anywhere between O and P. For a given member A (patient A) and the feasible target profit, the pairing member (i.e. member B or patient B) may be determined who allows the combined profit (average profit) from the member A and the member B to be equal to T.

In accordance with the present invention, the member B may be determined by using a geometrical construction of graph 400. In order to determine the ‘pairing’ member B, the following steps may be performed:

Step 1: Extend OT to double its length
Step 2: Determine difference between 2T and AA′
Step 3: Determine a point M on OP that is located at the determined distance (from step 2) from point 0.
Step 4: Draw a horizontal line starting from M, the intersection of the horizontal line and line PQR will indicate location of pairing member B/patient B.
Thus, it may be derived from above that

(P(A)+P(B))/2=feasible target profit=T

Hence, P(B)=2*T−P(A) Eq. 4

Hence, the pairing member B (patient B) may be determined or identified using the feasible target profit and the profit generated from the member A according to the above equation.

By definition,
P(B)<P(MAX), where P (MAX) is a maximum profit generated from a member
Therefore, 2*T−P(A)<P(MAX) [from equation 4]

### Or T<(0.5)*(P(A)+P(MAX))

This is the upper bound for the feasible target profit.

In accordance with another embodiment of the invention, there may be scenarios in which a different constant might be present. This may be due to the fact that different employers pay different medical insurance premiums, and EWR shall vary from employer to employer. In addition, employers may change their contributions to employees' healthcare plan annually. For such scenarios, the present invention proposes a method for identifying pairing members (such as patients) by using the distribution of MBEs of the members.

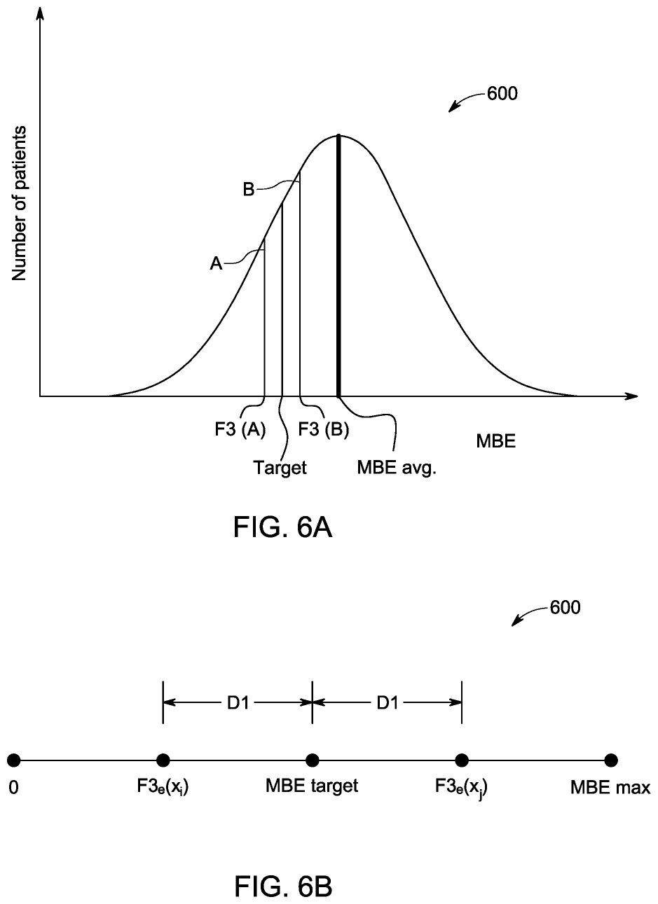

To explain the method for identifying pairing members (such as patients) by using the distribution of MBE of the members, FIGS. 6a and 6b will be used.

FIG. 6a shows an example of a distribution of Medical Benefit Expense (MBE) 600 of the members/patients. For the identification of the pairing members, it may be assumed that the distribution of MBE for the members (such as patients) is a normal distribution as shown in FIG. 6a. As can be understood by a person ordinarily skilled in the art, if the distribution is not a normal distribution, the present method for identifying the pairing members can still be applied with a few minor modifications.

The MBE distribution curve 600 has a population mean MBE_{avg} as shown by the thick line at the center of the curve 600. Typically, in the conventional healthcare insurance system 200, the insurance provider 204 selects members such that the average MBE of the selected members is MBE_{Target} which is lower than MBE_{avg}.

Assuming A is a member of the selected group with MBE of F3(A), and

F3(A)<MBE_{Target} Eq. 5

In accordance to an embodiment of the invention, the pairing member B (patient B) may be identified as below:

F3(A)+F3(B)=2*MBE_{Target} Eq. 6

FIG. 6b shows another example of a distribution of estimated Medical Benefit Expense (MBE) 600 of the members/patients in accordance with further embodiment of the invention. It may be assumed that there are N members (patients) which may be represented by x₁, x₂, x₃ . . . xᵢ, xᵢ₊₁ . . . x_{N} in the subgroup with a target MBE_{Target}.

The actual MBE of member xᵢ may be denoted by F3(xᵢ). F3(xᵢ) may be identified, for example, from the historical expenditure data of the member xᵢ. The estimated MBE of member xᵢ may be represented by F3ₑ(xᵢ), which could be determined by applying one or more of a number of available statistical methods. Also, the estimated MBE may be determined based on parameters like historical medical expenses, health history, outstanding medical fees, and age. For example, different weightages may be applied to these parameters in a statistic model, to estimate MBE for member xᵢ.

Further, assuming is an ascended order list of the estimated MBEs, L may be represented as

L={F3ₑ(x₁),F3ₑ(x₂),F3ₑ(xᵢ),F3ₑ(xᵢ+1),F3ₑ(x_{N})} Eq. 7

Such that:

F3ₑ(xᵢ+1)>F3ₑ(xᵢ) for i=1 to N−1 Eq. 8

Given F3ₑ (xᵢ), the present invention identifies its pairing member in the subgroup. The first step is to calculate the distance (D1) of member xᵢ from the target MBE.

STEP 1: Calculate delta(xᵢ) or D1=MBE_{Target}−F3ₑ(xᵢ) Eq. 9,

Where delta (xᵢ)=Distance of xᵢ from MBE_{Target}

Therefore, F3ₑ(xᵢ)=MBE_{Target}−delta(xᵢ) Eq. 10

STEP 2: Identify j such that F3ₑ(xⱼ)=MBE_{Target}+delta(xᵢ) Eq. 11

It is to be noted that the suffix of x in delta in Equation (11) is i.

According to an embodiment of the present invention, the following is a pseudo code for the proposed method:

```
For i=1 to N do {
F3ₑ(i) → Current MBE
  Delta (i)=MBE_{Target}−F3ₑ(i)
  MBE_{Pairing-member} = MBE_{Target} + Delta (i)
While ((MBE_{Pairing-member}>F3ₑ (i+1)). AND. (F3ₑ (i+1). NOT PAIRED))
  /*move to next MBE*/
  i= i+1;
  j=i−1; /*j is location of pair */
  Mark (i,j) as pair
  End While
} */End For loop */
```

In other words, the present invention identifies the pairing member j such that the distance of F3ₑ(xᵢ) from MBE_{Target} is equal to the distance between the MBE_{Target} and the F3ₑ(xⱼ).

As can be understood by a person ordinarily skilled in the art, the mentioned pseudo code is just an example, and similar or different codes can be written to achieve the same objective of identifying pairing members by using target MBE, as proposed in the present invention.

Now that the process/theory of identifying “pairing member” is described in conjunction with FIGS. 5 and 6, the embodiments and process of payment of medical service fees to the medical service providers by the set of patients of the P2P network 300 will be described.

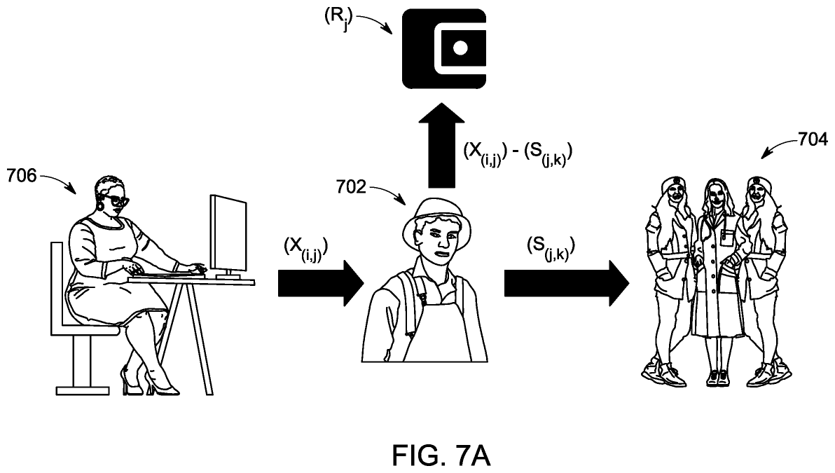

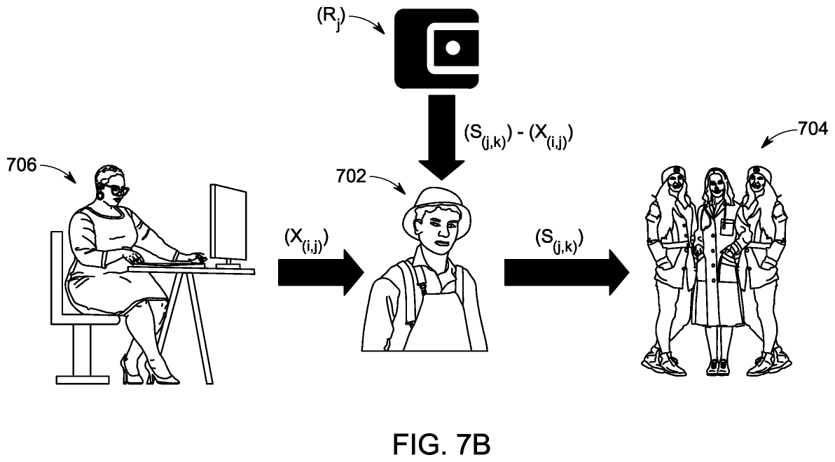

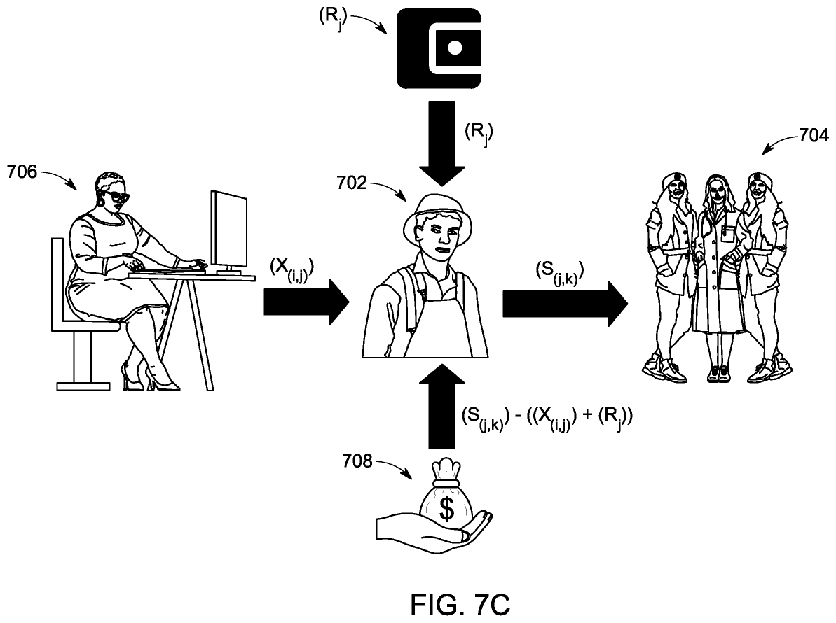

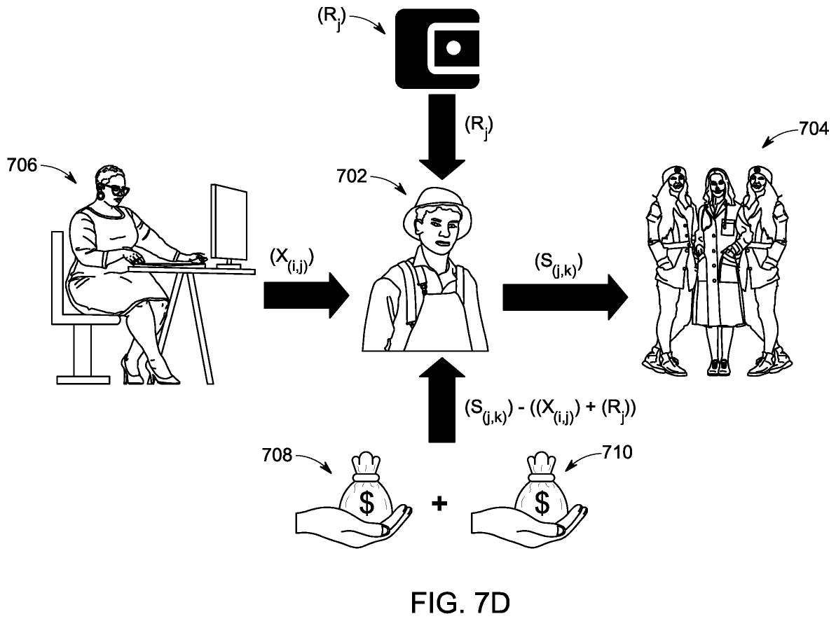

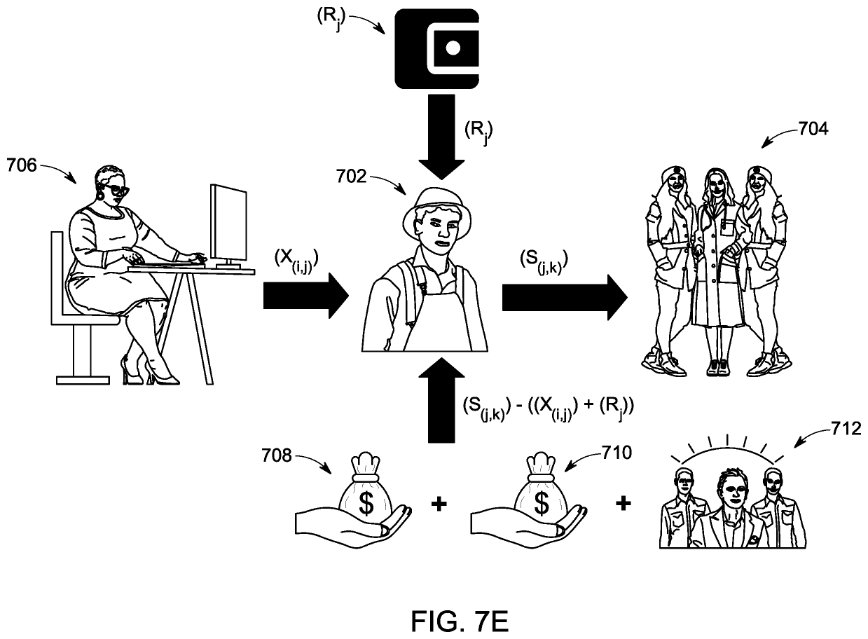

FIG. 7a-7e describe different embodiments of transferring outstanding medical service fee (S_{(j,k)}) to an account associated with a medical/healthcare service provider 704, from an account associated with a patient 702 of the set of patients 402. For instance, FIG. 7a describes an embodiment, in which the patient 702 receives a first amount of resources (X_{(i,j)}) from a first donor 706, of the set of donors 406, in a first account associated with the patient 702 on the P2P platform 300. The first donor 706 includes, but is not limited to, employers, government, healthcare or public welfare foundations, NGOs, clients/customers, parents, individuals, and the like. In an embodiment of the present invention, the first amount may be received monthly. In another embodiment of the invention, the first amount may be received quarterly, yearly, or at any other frequency. In further embodiments of the invention, the first amount may be received only once, or may be received at irregular intervals based on the requirements of the patient 702. Further, in accordance with an embodiment of the invention, the first amount may be predetermined or it may vary based on various parameters such as, but not limited to, medical expenditure of the patient 702, age, total salary, medical history, financial capability, location of residence, employment tenure of the patient, services provided to clients/customers, and the like.

In accordance with an embodiment of the present invention, if the received first amount of resources (X_{(i,j)}) is greater than the outstanding medical service fee (S_{(j,k)}), then the P2P platform 300 is configured to transfer the outstanding medical service fee (S_{(j,k)}) from the first account, to a second account associated with the medical/healthcare service provider 704. As described in conjunction with above figures, the medical service fee is paid, for example, when one or more patients from the set of patients 402 avail the medical services offered by the medical service provider 404. The medical service fee to the medical service provider 404 may be paid one time, or may be paid periodically such as monthly, quarterly or yearly.

In other words, when the first amount of resources received from the first donor 706 is greater than the medical service fee incurred by the patient 702, then “one patient and one donor” model may be applied. In an embodiment of the invention, the P2P platform 300 is configured to store the surplus amount ((X_{(i,j)})−(S_{(j,k)})) as a reservoir (Rⱼ) in the first account. In other words, the P2P platform 300 is configured to store the surplus amount of resources, including historical surplus amount of resources and current surplus amount of resources in the reservoir (Rⱼ).

FIG. 7b illustrates further embodiment of the present invention. In accordance with this embodiment, if the first amount of resources (X_{(i,j)}) is less than the outstanding medical service fee (S_{(j,k)}), then the P2P platform 300 (or one or more computing devices in the P2P platform 300) is configured to calculate or determine a second amount of resources (balance amount=(S_{(j,k)})−(X_{(i,j)})). After this, the P2P platform 300 determines if the second amount of resources ((S_{(j,k)}−(X_{(i,j)})) is available in the reservoir (Rⱼ) of the first account. If the amount in the reservoir (Rⱼ) of the account is sufficient to pay the second amount of resources, then the P2P platform 300 is configured to transfer the outstanding medical service fee (S_{(j,k)}) from the first account associated with the patient 702, to the second account associated with a medical/healthcare service provider 704. In this case, the first amount of resources and the resources present in the reservoir (Rⱼ) are used to pay the outstanding medical service fee (S_{(j,k)}).

FIG. 7c illustrates further embodiment of the present invention. In accordance with this embodiment, if it is determined that the sum of the first amount of resources and the surplus amount of resources in the reservoir (Rⱼ) is less than the medical service fee (((X_{(i,j)})+(Rⱼ))<(S_{(j,k)})), then the P2P platform 300 is configured to identify a second patient 708 as the “pairing member” of the patient 702 to receive balance payment ((S_{(j,k)})−((X_{(i,j)})+(Rⱼ))). The process of identifying the pairing member is already explained in conjunction with FIGS. 5 and 6.

Once the second patient 708 is identified, the P2P platform 300 may be configured to transmit a request to the second patient 708 to transfer the balance amount of resources to the first account associated with the patient 702. Once the request is approved, the P2P platform 300 may be configured to receive the balance amount in the first account associated with the patient 702. In other words, when the sum of the first amount of resources received from the first donor and the surplus amount of resources present in the reservoir (Rⱼ) of the account is less than the medical service fee, then “one patient and two donors” model may be applied. In an embodiment, the balance payment may be received from a third account of the second patient 708.

In accordance with another embodiment of the present invention, the P2P platform 300 may transfer the balance amount from the third account of the second patient 708 automatically, without sending any request for approval to the second patient 708.

In accordance with an embodiment of the present invention, the balance payment is transferred using a reservoir of funds in the third account of the second patient 708.

FIG. 7d illustrates further embodiment of the present invention. In accordance with this embodiment, if it is determined that the medical service fee is much greater than the sum of the first amount of resources and the surplus amount of resources in the reservoir (Rⱼ), then one patient and multiple donors/patients (708, 710) model may be applied, where the medical service fee is compensated by multiple donors.

FIG. 7e illustrates further embodiment of the present invention. In accordance with this embodiment, if it is determined that the medical service fee is much greater than the sum of the first amount of resources and the surplus amount of resources in the reservoir (Rⱼ), and the contributions of the multiple donors/patients (708, 710), then the P2P platform 300 is configured to receive the balance payment from a community 712. The community 712 may be a set of individuals or entities who may transfer funds to the first account associated with the patient 702.

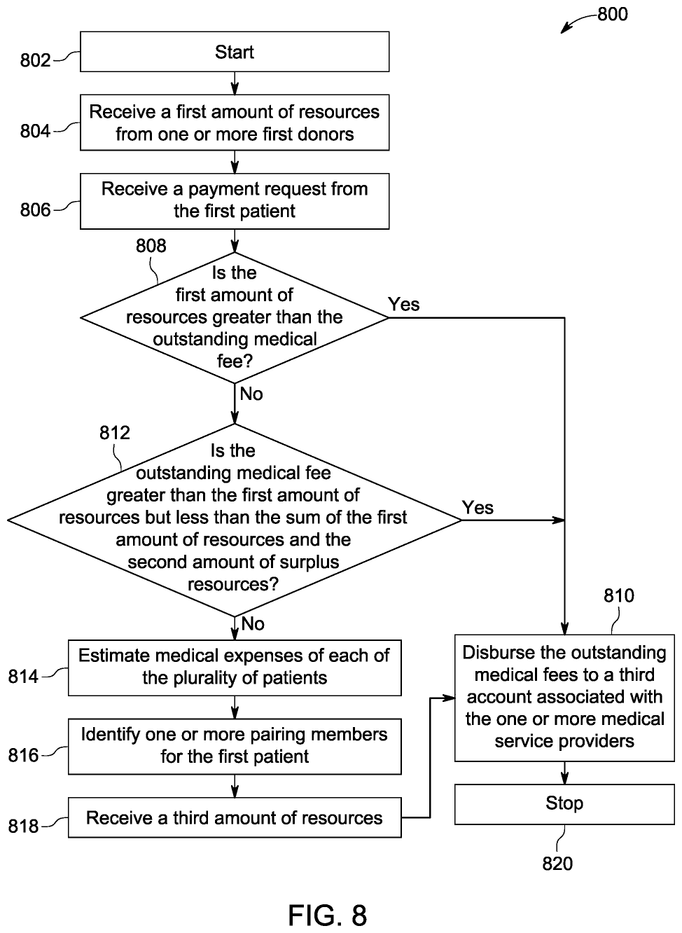

FIG. 8 describes a method 800 for making payment to the medical service providers 404, in accordance with an embodiment of the present invention. The method is performed by the P2P platform 300. The method begins at step 802. At step 804, the P2P platform 300 receives a first amount of resources (X_{(i,j)}) from one or more first donors (D₍ᵢ₎), of the set of donors 406, in a first account associated with the patient (P₍ⱼ₎) of the set of patients 402. The first account stores the first amount of resources and a surplus amount of resources (or second amount of surplus resources) associated with the patient 702. The second amount of surplus resources may be those resources that the patient 702 has received in the past from the first donor (or other donors), but has not utilized them in the past. The details of the first amount of resources and the surplus amount of resources (or second amount of surplus resources R₍ⱼ₎) may be understood in conjunction with FIGS. 7a-7e.

As discussed in conjunction with above-figures, the plurality of donors and the plurality of patients are associated with the P2P platform 300, and the P2P platform 300 is configured to manage accounts of each of the plurality of patients and/or the plurality of donors.

In step 806, the P2P platform 300 receives a payment request from the patient 702. The payment request may include outstanding medical fee (S_{(j,k)}), payment due date, and details of the one or more medical service providers (V₍ₖ₎) associated with the outstanding medical fee (such as name and address of the one or more medical service providers, details of medical services used, prescription etc.). In accordance with another embodiment of the present invention, the payment request may be received directly from the one or more medical service providers. In accordance with further embodiment of the present invention, the payment request may be made by filling a form, uploading one or more documents, or a predetermined process set by the P2P platform 300.

Thereafter, at step 808, the P2P platform 300 determines whether the received first amount of resources is greater than the outstanding medical service fee ((X_{(i,j)})>(S_{(j,k)})) that the patient (P₍ⱼ₎) needs to pay to the one or more medical service providers (V₍ₖ₎).

If it is determined that the first amount of resources is greater than the medical service fee ((X_{(i,j)})>(S_{(j,k)})), the method moves to next step 810. In step 810, the outstanding medical services fee is transferred from the first account associated with the patient Po) to a third account associated with the one or more medical service providers (V₍ₖ₎). In other words, when the first amount of resources received from the first donor is greater than the medical service fee incurred by the first patient P₍ⱼ₎, then “one patient and one donor model” may be applied. In an embodiment of the invention, the P2P platform 300 stores the surplus amount ((X_{(i,j)})−(S_{(j,k)})) as a reservoir (Rⱼ) in the first account.

On the other hand, if it is determined at step 808 that the first amount of resources is less than the medical service fee ((X_{(i,j)})<(S_{(j,k)})), then the method moves to step 812. In step 812, the P2P platform 300 determines if the balance amount ((S_{(j,k)})−(X_{(i,j)})) is available in the reservoir (Rⱼ) of the first account that stores the second amount of surplus resources. In other words, the P2P determines whether the outstanding medical fee is greater than the first amount of resources but less than the sum of the first amount of resources and the second amount of surplus resources. If the amount in the reservoir of the first account is sufficient to pay the balance amount, the method moves to step 810 where the P2P platform 300 may be configured to disburse/transfer the outstanding medical service fee (S_{(j,k)}) from the first account to the second account associated with the one or more medical service providers (V₍ₖ₎). In this case, the first amount of resources and the resources present in the reservoir (Rⱼ) (second amount of surplus resources) are used to make the payment to the one or more medical service providers (V₍ₖ₎).

Alternatively, if it is determined at step 812 that the sum of the first amount of resources and the second amount of surplus resources in the reservoir (Rⱼ) is less than the outstanding medical service fee (((X_{(i,j)})+(Rⱼ))<(S_{(j,k)})), then the method moves to step 814. In the step 814, the P2P platform 300 estimates medical expenses (or medical benefit expenses) of each of the plurality of patients based on a plurality of parameters. Specifically, for each patient, the medical benefit expense is estimated based on their historical medical expenses, health history, outstanding medical fees, and age, and the like. Also, one or more known statistical models may be used to estimate the medical benefit expense for each of the patients, by adding different weights to the parameters mentioned above.

Based on the estimation of the medical benefit expenses, the P2P platform 300, at step 816, identifies one or more second patients of the plurality of patients from the P2P platform 300 as the “pairing members” to receive the balance payment ((S_{(j,k)})−((X_{(i,j)})+(Rⱼ))). Specifically, the P2P platform 300 is configured to identify one or more second patients (pairing members) such that an average estimated medical benefit expense of the first patient and the one or more second patients is equal to the target medical benefit expense (MBE_{Target}) set by the P2P network 300. In accordance with an embodiment of the present invention, the target MBE is set by the P2P platform 300. In an embodiment, the P2P platform 300 sets the MBE_{Target} which is lower than the MBE_{avg} (i.e. average of the medical expenditures of all the member of the P2P platform 300). In accordance with another embodiment of the present invention, the P2P platform 300 may identify the one or more second patients such that the average estimated medical benefit expense of the first patient and the one or more second patients is within a predefined range of the target medical benefit expense (MBE_{Target}). For example, if the MBE_{Target} is 300 units, the defined range is 5%, then the P2P platform 300 may identify the one or more second patients such that the average estimated medical benefit expense of the first patient and the one or more second patients is between 285 to 315 units.

Once the one or more second patients as pairing members are identified, the method moves to step 818. At the step 818, the P2P platform 300 receives a third amount of resources in the first account from an account associated with the one or more second patients. The third amount of resources is equal to the difference between the outstanding medical fee and the sum of the first amount of resources and the second amount of surplus resources. In accordance with an embodiment of the present invention, the third amount may be received in response to transmitting a request for approval of resource transfer to the one or more second patients to transfer the third amount in the first account. In accordance with another embodiment of the present invention, the third amount is transferred automatically by the P2P platform 300 from the account associated with the one or more second patients to the first account, without sending any request to the one or more second patients.

Thereafter, the method moves to the step 810, at which the P2P platform 300 may be configured to disburse/transfer the outstanding medical service fee (S_{(j,k)}) from the first account to the second account associated with the one or more medical service providers (V₍ₖ₎). In this case, the first amount of resources, the resources present in the reservoir (Rⱼ) (second amount of surplus resources), and the third amount of resources are used to make the payment to the one or more medical service providers (V₍ₖ₎).

In accordance with an embodiment of the invention, if the P2P platform 300 determines that the outstanding medical service fee is greater than the first amount of resources and the second amount of surplus resources, but less than contribution of two donors, then one patient and two donors model may be applied. In this case, the medical service fee is compensated by two donors/patients. In accordance with another embodiment of the invention, if the P2P platform 300 determines that the outstanding medical service fee is much greater than the sum of the first amount of resources and the second amount of surplus resources in the reservoir (Rⱼ) of the first account associated with the patient P(₍ⱼ₎), then one patient and multiple donors/patients model may be applied, where the outstanding medical service fee is compensated by multiple donors/patients.

The method stops at step 820.

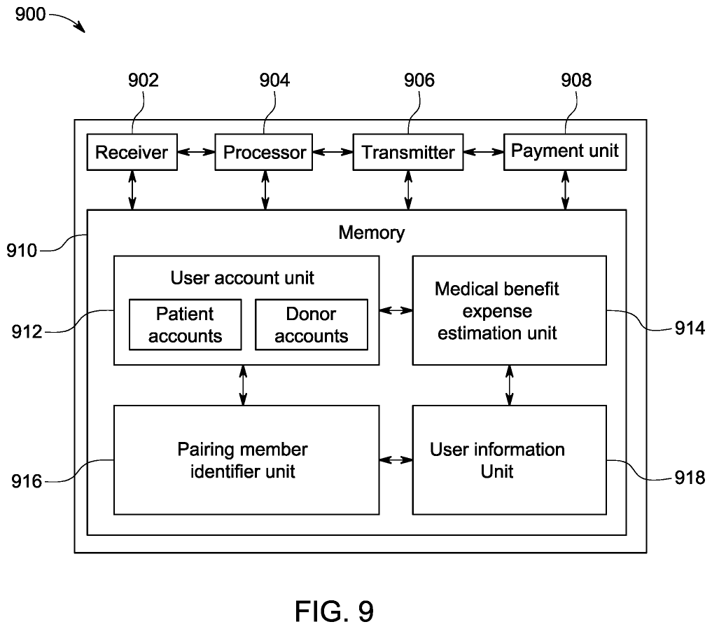

FIG. 9 illustrates a system 900 (which is peer to peer healthcare payment platform or P2P platform, as mentioned above) for making payment to the medical service providers, in accordance with an embodiment of the present invention. The system 900 may be a computing device (e.g. a computing node) which executes the functions of the P2P platform.

In accordance with an embodiment of the present invention, the system 900 may include, but not limited to, a receiver 902, a processor 904, a transmitter 906, a payment unit 908, and a memory 910, which are communicatively coupled with each other. The memory 910 may be an integrated circuit (IC) memory chip containing any form of random-access memory (RAM) or read-only memory (ROM), a floppy disk, a compact disk read-only memory (CD-ROM), a hard disk drive, a digital video disc (DVD), a flash memory card, external subscriber identity module (SIM) card or any other medium for storing non-transitory digital information. In accordance with an embodiment of the present invention, the memory 910 may include one or more units or modules, such as a user account unit 912, a medical benefit expense estimation unit 914, a pairing member identifier unit 916, and a user information unit 918, which are communicatively coupled with each other. A few of these units may be outside of the memory 910 as well, and in the system 900, without departing from the scope of the present invention or affecting the functioning of the system 900.

In accordance with an embodiment of the present invention, the receiver 902 may be configured to receive a first amount of resources from one or more first donors, of a plurality of donors, in a first account associated with a first patient of the plurality of patients. The first account stores the first amount of resources and a second amount of surplus resources associated with the patient. The details of the second amount of surplus resources are already discussed above. In accordance with an embodiment of the present invention, the plurality of donors and the plurality of patients are associated with the system 900, which may be configured to manage accounts of each of the plurality of patients and/or the plurality of donors. After receiving the first amount of resources, the receiver 902 may be configured to store the first amount of resources in the memory 910, specifically in the first account which is stored on the user account unit 912 of the memory 910.

In accordance with an embodiment of the present invention, the receiver 902 may be configured to receive a payment request from a first patient. The payment request may include an outstanding medical fee, payment due date, and details of the one or more medical service providers associated with the outstanding medical fee. Alternatively, the payment request may be received from one or more medical service providers associated with the outstanding medical fee. The details of the request are already discussed above.

In accordance with an embodiment of the present invention, the receiver 902 is further configured to receive a third amount of resources from a second account of one or more second patients in the first account. The concept of second patients and the third amount of resources is also already discussed above.

The processor 904 may include one or more microprocessors, microcontrollers, digital signal processors (DSPs), state machines, logic circuitry, or any other device or devices that process information based on operational or programming instructions. Such operational or programming instructions may be stored in the memory 910. One of ordinary skill in the art will recognize that when the processor 904 has one or more of its functions performed by a state machine or logic circuitry, the memory 910 containing the corresponding operational instructions can be embedded within the state machine or logic circuitry.

In accordance with an embodiment of the present invention, the processor 904 may be configured to command the user account unit 912 to create accounts for each of the plurality of patients and/or plurality of donors on the system 900. In accordance with an embodiment of the present invention, the processor 904 may also command the user account unit 912 to create accounts of the one or more medical service providers on the system 900.

In accordance with an embodiment of the present invention, once the accounts are created, patients and/or donors and/or medical service providers can store resources (e.g. money) in the accounts and use them to transact with each other.

In accordance with further embodiment of the present invention, the processor 904 may command the user account unit 912 to fetch account details of the one or more of the plurality of patients and/or plurality of donors to determine amount of resources stored in each account of the plurality of patients and/or plurality of donors.

In accordance with further embodiment of the present invention, the processor 904 may be configured to compare the amount of resources available in an account of a patient with the outstanding medical fee to be paid by the patient. In accordance with further embodiment of the present invention, the processor 904 may be configured to determine, in response to receiving the payment request from the first patient by the receiver 902, if the outstanding medical fee of the one or more medical service providers is greater than the first amount of resources, or sum of the first amount of resources and the second amount of surplus resources in the account associated with the first patient.

In accordance with further embodiment of the present invention, the processor 904 may command the Medical Benefit Expense (MBE) Estimation Unit 914 to estimate medical benefit expenses of each of the plurality of patients based on a plurality of parameters, in response to a determination that the outstanding medical fee is greater than the sum of the first amount of resources and the second amount of surplus resources. The plurality of parameters includes historical medical expenses, health history, outstanding medical fees, and age, as already described above.

In accordance with further embodiment of the present invention, the processor 904 may command the Pairing Member Identifier Unit 916 to identify one or more second pairing patients, from the plurality of patients, for the first patient based on the estimation of the medical benefit expenses. The one or more second pairing patients are identified such that an average estimated medical benefit expense of the first patient and the one or more second pairing patients is equal to a target medical benefit expense.

In accordance with an embodiment of the present invention, when the one or more second pairing patients are determined, the transmitter 906 may be configured to send a request for approval to the identified one or more second pairing patients to transfer the third amount of resources to the first account. The third amount of resources is equal to the difference between the outstanding medical fee and the sum of the first amount of resources and the second amount of surplus resources.

In accordance with an embodiment of the present invention, once the third amount of resources are received in the first account by the receiver 902 in response to the request of approval sent by the transmitter 906, the payment unit 908 may be configured to disburse the outstanding medical fees to a third account associated with the one or more medical service providers from the first account. The disbursement is performed using one or more of the first amount of resources, the second amount of surplus resources, and the third amount of resources, in a manner as described above in conjunction with FIGS. 7a-7e and FIG. 8. In addition, the payment unit 908 may be configured to store a surplus amount of resources as the second amount of surplus resources in the first account (based on a determination that the outstanding medical fee is less than the first amount of resources). The surplus amount of resources is the difference between the outstanding medical fee and the first amount of resources.

In accordance with an embodiment of the present invention, the memory 910 includes the user information unit 918 that may be configured to store the mapping of the plurality of patients and their respective donors. In addition, the user information unit 918 may be configured to store other details of the patients, such as name, age, historical medical expenses, health history, outstanding medical fees, and patient identity. In addition, the user information unit 918 may be configured to store similar details of the plurality of donors and one or more medical service providers.

Since the system 900 functions as a P2P platform that manages accounts of a plurality of patients, and/or donors, and/or medical service provides, it is imperative that the system 900 operates in a profitable and stable manner, and the “outgoing funds” (payment of medical expense bills) are equal to or ideally less than “incoming funds” (receipt from donors). To ensure stability, the system 900 or specifically the processor 904 performs a few additional steps, as mentioned below.

In accordance with an embodiment of the invention, if the system 900 determines that the frequency of the first patient to visit Medical Doctor Office (MDO) in a year is greater than a predetermined threshold, then the first patient may be moved to a different group of members where the first patient's frequency of visits is within a standard deviation. For instance, if the frequency of the first patient visiting the MDO is double than the average frequency of visits of all the members associated with the system 900, then the first patient is moved to a different group of members.

In accordance with further embodiments of the invention, the system 900 may be stable if the amount in the reservoir (collective reservoir of all the accounts on the system 900) is greater than a predetermined threshold. In other words, the sum of the amount in the reservoir of all the patients' accounts in the system 900 should be greater than the predetermined threshold to maintain stability of the system 900. In particular, the sum of the amount in the reservoir of all the patients' accounts in the system 900 should be greater than sum of monthly payments to the medical service providers 404.

Thus, the system 900 may be stable when the below mentioned condition is fulfilled.

Sum(R₍ⱼ₎)>=N*Sum(S_{(j,k)}), where

Sum (R₍ⱼ₎) is the sum of amount in reservoir of all the patients on the system 900;
N is the number of months for which the system 900 has available funds; and
Sum (S_{(j,k)}) is the sum of medical service fee paid to the medical service providers 404.

The system 900 determines, at the end of year, if the amount in a reservoir of any patient is greater than a predetermined threshold. If the amount in the reservoir of any patient is greater than the predetermined threshold, then the patient is eligible to become a donor, and may also be rewarded for health achievement and placed in a special group.

As an exemplary embodiment, average expense, standard deviation, and monthly payment for age group 0-18 years is shown below (Table 1)

TABLE 1

| LOW RISK | Age 0-18 years |
|---|---|
| Average Expense | $ 251.92 |
| Standard Deviation | $ 100.00 |
| Member Monthly Payment | $ 250.00 |

In order to test the present invention, Monte Carlo simulation technique is used by generating random numbers.

As an exemplary embodiment, a list of MBEs for twenty two children generated by Monte Carlo Simulation is shown in table 2 below.

TABLE 2

| Monthly Medical Expense | Monthly Premium | (Premium − MBE) |
|---|---|---|
| $ 357.17 | $ 250.00 | −$ 107.17 |
| $ 112.31 | $ 250.00 | $ 137.69 |
| $ 330.59 | $ 250.00 | −$ 80.59 |
| $ 356.27 | $ 250.00 | −$ 106.27 |
| $ 306.02 | $ 250.00 | −$ 56.02 |
| $ 179.47 | $ 250.00 | $ 70.53 |
| $ 362.29 | $ 250.00 | −$ 112.29 |
| $ 73.92 | $ 250.00 | $ 176.08 |
| $ 254.03 | $ 250.00 | −$ 4.03 |
| $ 260.93 | $ 250.00 | −$ 10.93 |
| $ 232.91 | $ 250.00 | $ 17.09 |
| $ 533.27 | $ 250.00 | −$ 283.27 |
| $ 279.91 | $ 250.00 | −$ 29.91 |
| $ 53.61 | $ 250.00 | $ 196.39 |
| $ 390.07 | $ 250.00 | −$ 140.07 |
| $ 339.04 | $ 250.00 | −$ 89.04 |
| $ 270.92 | $ 250.00 | −$ 20.92 |
| $ 131.92 | $ 250.00 | $ 118.08 |
| $ 477.49 | $ 250.00 | −$ 227.49 |
| $ 150.56 | $ 250.00 | $ 99.44 |
| $ 248.52 | $ 250.00 | $ 1.48 |
| $ 359.58 | $ 250.00 | −$ 109.58 |

In an exemplary embodiment, table 3 indicates estimated MBEs for the twenty two young patients.

TABLE 3

| Estimated MBE | Patient ID |
|---|---|
| $ 190.46 | 1 |
| $ 416.92 | 2 |
| $ 152.28 | 3 |
| $ 326.86 | 4 |
| $ 41.07 | 5 |
| $ 246.92 | 6 |
| $ 403.96 | 7 |
| $ 350.78 | 8 |
| $ 228.16 | 9 |
| $ 341.18 | 10 |
| $ 468.82 | 11 |
| $ 411.74 | 12 |
| $ 108.88 | 13 |
| $ 262.42 | 14 |
| $ 151.98 | 15 |
| $ 113.65 | 16 |
| $ 286.78 | 17 |
| $ 277.48 | 18 |
| $ 286.47 | 19 |
| $ 238.41 | 20 |
| $ 305.59 | 21 |
| $ 439.57 | 22 |

In accordance with an embodiment of the invention, the pairing members may be identified by sorting the table 3, as shown in table 4 below.

TABLE 4

| Patient ID | Estimated MBE |
|---|---|
| 5 | $ 41.07 |
| 13 | $ 108.88 |
| 16 | $ 113.65 |
| 15 | $ 151.98 |
| 3 | $ 152.28 |
| 1 | $ 190.46 |
| 9 | $ 228.16 |
| 20 | $ 238.41 |
| 6 | $ 246.92 |
| 14 | $ 262.42 |
| 18 | $ 277.48 |
| 19 | $ 286.47 |
| 17 | $ 286.78 |
| 21 | $ 305.59 |
| 4 | $ 326.86 |
| 10 | $ 341.18 |
| 8 | $ 350.78 |
| 7 | $ 403.96 |
| 12 | $ 411.74 |
| 2 | $ 416.92 |
| 22 | $ 439.57 |
| 11 | $ 468.82 |

Once the above sorting is performed, the members may be paired in accordance with the algorithm described above, and as shown below in table 5.

TABLE 5
Assumed target MBE = $300

| | | |
|---|---|---|
| Pick | 17, 21 | 296.1816 |
| Pick | 4, 19 | 306.6648 |
| Pick | 10, 18 | 302.169 |
| Pick | 8, 14 | 306.5975 |
| Pick | 7, 6 | 325.4419 |
| Pick | 12, 20 | 325.0744 |
| Pick | 2, 9 | 322.5426 |
| Pick | 22, 1 | 315.0135 |
| Pick | 11, 3 | 310.5512 |

As shown below, the system 900 allows some threshold range (e.g. +/−5% to 10%) from the target MBE to identify the pairing members. For example, in the table below, the target MBE is 300, however the pairing members may have estimated average MBE between the range of 270 to 330.

The difference from the target for each pair in the first round of pairing is shown below:

TABLE 6:
Difference from the Target

−3.818375
6.664776
2.169009
6.597526
25.44189
25.07438
22.54261
15.0135
10.55122
List of Symbols used above:
A, B = Members of an insurance company
MBE = Medical Benefit Expense
P(A), P(B) = Profit generated from A, B
P(MAX) = Maximum profit generated from a member
F1(A), F1(B) = Contribution by employer for A, B
F2(A), F2(B) = Insurance Payment by A, B
F3(A), F3(B) = MBE for A, B
O(A), O(B) = Operational cost for A, B
M(A), M(B) = Marketing cost for A, B
EWR = Employer Worker Ratio = F1/F2
Subscript Definitions:
F3ₑ = Estimated MBE
MBE_{Target} = Target MBE set by insurance
MBE_{Pairing-member} = A variable used to identify the pairing member, given a target MBE and one of the members
Delta (xᵢ) = Distance of xᵢ from MBE_{Target}
Xᵢ = i-th element in the list of members

As can be understood from the example mentioned above, pairing of patients (members 202 of platform 200) can be performed.

The present disclosure may be realized in hardware, or a combination of hardware and software. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system having an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments that fall within the scope of the appended claims.

I/We claim:

1. A method performed by a peer to peer healthcare payment platform, the method comprising:
receiving a first amount of resources from one or more first donors, of a plurality of donors, in a first account associated with a first patient of the plurality of patients, wherein the first account stores the first amount of resources and a second amount of surplus resources associated with the first patient, wherein the plurality of donors and the plurality of patients are associated with the peer to peer healthcare payment platform, and wherein the peer to peer healthcare payment platform is configured to manage accounts of each of the plurality of patients;
receiving a payment request from the first patient, wherein the payment request comprises an outstanding medical fee, payment due date, and details of one or more medical service providers associated with the outstanding medical fee;
determining, in response to receiving the payment request, if the outstanding medical fee of the one or more medical service providers is greater than the sum of the first amount of resources and the second amount of surplus resources;
in response to a determination that the outstanding medical fee is greater than the sum of the first amount of resources and the second amount of surplus resources, estimating medical benefit expenses of each of the plurality of patients based on a plurality of parameters, wherein the plurality of parameters comprises historical medical expenses, health history, outstanding medical fees, and age;
identifying one or more second pairing patients, from the plurality of patients, for the first patient based on the estimation of the medical benefit expenses, wherein the one or more second pairing patients are identified such that an average estimated medical benefit expense of the first patient and the one or more second pairing patients is equal to a target medical benefit expense;
receiving a third amount of resources from a second account of the one or more second pairing patients in the first account, wherein the third amount of resources is equal to the difference between the outstanding medical fee and the sum of the first amount of resources and the second amount of surplus resources; and
disbursing the outstanding medical fee to a third account associated with the one or more medical service providers from the first account, wherein the disbursement is performed using the first amount of resources, the second amount of surplus resources, and the third amount of resources.

2. The method of claim 1, wherein the plurality of donors comprises one or more of employers, Government Organizations, healthcare or public welfare foundations, Non-Governmental Organizations (NGOs), clients, customers, parents, and individuals.

3. The method of claim 1, wherein the plurality of donors comprises one or more patients of the plurality of patients.

4. The method of claim 1 further comprising:
determining if the outstanding medical fee is less than the first amount of resources;
in response to a determination that the outstanding medical fee is less than the first amount of resources, disbursing the outstanding medical fee to the third account from the first account, wherein the disbursement is performed using the first amount of resources; and
storing a surplus amount of resources as the second amount of surplus resources in the first account based on a determination that the outstanding medical fee is less than the first amount of resources, wherein the surplus amount of resources comprises the difference between the outstanding medical fee and the first amount of resources.

5. The method of claim 1 further comprising:
determining if the outstanding medical fee is greater than the first amount of resources but less than the sum of the first amount of resources and the second amount of surplus resources;
in response to a determination that the outstanding medical fee is greater than the first amount of resources but less than the sum of the first amount of resources and the second amount of surplus resources, disbursing the outstanding medical fee to the third account from the first account, wherein the disbursement is performed using the first amount of resources and the second amount of surplus resources.

6. The method of claim 1, wherein the target medical benefit expense is set by the peer to peer healthcare payment platform.

7. The method of claim 1, wherein the first amount of resources is received in the first account at a periodic frequency.

8. A peer to peer healthcare payment platform, the peer to peer healthcare payment platform comprising:
a receiver configured to:
receive a first amount of resources from one or more first donors, of a plurality of donors, in a first account associated with a first patient of the plurality of patients, wherein the first account stores the first amount of resources and a second amount of surplus resources associated with the first patient, wherein the plurality of donors and the plurality of patients are associated with the peer to peer healthcare payment platform, and wherein the peer to peer healthcare payment platform is configured to manage accounts of each of the plurality of patients; and
receive a payment request from the first patient, wherein the payment request comprises an outstanding medical fee, payment due date, and details of one or more medical service providers associated with the outstanding medical fee;
a processor configured to:
determine, in response to receiving the payment request, if the outstanding medical fee of the one or more medical service providers is greater than the sum of the first amount of resources and the second amount of surplus resources;
estimate medical benefit expenses of each of the plurality of patients based on a plurality of parameters, in response to a determination that the outstanding medical fee is greater than the sum of the first amount of resources and the second amount of surplus resources, wherein the plurality of parameters comprises historical medical expenses, health history, outstanding medical fee, and age;
identify one or more second pairing patients, from the plurality of patients, for the first patient based on the estimation of the medical benefit expenses, wherein the one or more second pairing patients are identified such that an average estimated medical benefit expense of the first patient and the one or more second pairing patients is equal to a target medical benefit expense; and
wherein the receiver is further configured to receive a third amount of resources from a second account of the one or more second pairing patients in the first account, wherein the third amount of resources is equal to the difference between the outstanding medical fee and the sum of the first amount of resources and the second amount of surplus resources; and
a payment unit configured to disburse the outstanding medical fee to a third account associated with the one or more medical service providers from the first account, wherein the disbursement is performed using the first amount of resources, the second amount of surplus resources, and the third amount of resources.

9. The peer to peer healthcare payment platform of claim 8, wherein the plurality of donors comprises one or more of employers, Government Organizations, healthcare or public welfare foundations, Non-Governmental Organizations (NGOs), clients, customers, parents, and individuals.

10. The peer to peer healthcare payment platform of claim 8, wherein the plurality of donors comprises one or more patients of the plurality of patients.

11. The peer to peer healthcare payment platform of claim 8, wherein the processor is further configured to determine if the outstanding medical fee is less than the first amount of resources,
wherein the payment unit is further configured to:
disburse, in response to a determination that the outstanding medical fee is less than the first amount of resources, the outstanding medical fee to the third account from the first account, wherein the disbursement is performed using the first amount of resources; and
store a surplus amount of resources as the second amount of surplus resources in the first account based on a determination that the outstanding medical fee is less than the first amount of resources, wherein the surplus amount of resources comprises the difference between the outstanding medical fee and the first amount of resources.

12. The peer to peer healthcare payment platform of claim 8, wherein the processor is further configured to determine if the outstanding medical fee is greater than the first amount of resources but less than the sum of the first amount of resources and the second amount of surplus resources, and
wherein the payment unit is further configured to disburse, based on a determination that the outstanding medical fee is greater than the first amount of resources but less than the sum of the first amount of resources and the second amount of surplus resources, the outstanding medical fee to the third account from the first account, wherein the disbursement is performed using the first amount of resources and the second amount of surplus resources.

13. The peer to peer healthcare payment platform of claim 8, wherein the target medical benefit expense is set by the peer to peer healthcare payment platform.

14. The peer to peer healthcare payment platform of claim 8, wherein the first amount of resources is received in the first account at a periodic frequency.

15. A non-transitory computer readable medium comprising instructions, that when executed by a processor in a peer to peer healthcare payment platform, cause the processor to perform:
receiving a first amount of resources from one or more first donors, of a plurality of donors, in a first account associated with a first patient of the plurality of patients, wherein the first account stores the first amount of resources and a second amount of surplus resources associated with the first patient, wherein the plurality of donors and the plurality of patients are associated with the peer to peer healthcare payment platform, and wherein the peer to peer healthcare payment platform is configured to manage accounts of each of the plurality of patients;
receiving a payment request from the first patient, wherein the payment request comprises an outstanding medical fee, payment due date, and details of one or more medical service providers associated with the outstanding medical fee;
determining, in response to receiving the payment request, if the outstanding medical fee of the one or more medical service providers is greater than the sum of the first amount of resources and the second amount of surplus resources;
in response to a determination that the outstanding medical fee is greater than the sum of the first amount of resources and the second amount of surplus resources, estimating medical benefit expenses of each of the plurality of patients based on a plurality of parameters, wherein the plurality of parameters comprises historical medical expenses, health history, outstanding medical fee, and age;
identifying one or more second pairing patients, from the plurality of patients, for the first patient based on the estimation of the medical benefit expenses, wherein the one or more second pairing patients are identified such that an average estimated medical benefit expense of the first patient and the one or more second pairing patients is equal to a target medical benefit expense;
receiving a third amount of resources from a second account of the one or more second pairing patients in the first account, wherein the third amount of resources is equal to the difference between the outstanding medical fee and the sum of the first amount of resources and the second amount of surplus resources; and
disbursing the outstanding medical fee to a third account associated with the one or more medical service providers from the first account, wherein the disbursement is performed using the first amount of resources, the second amount of surplus resources, and the third amount of resources.

16. The non-transitory computer readable medium of claim 15, wherein the plurality of donors comprises one or more of employers, Government Organizations, healthcare or public welfare foundations, Non-Governmental Organizations (NGOs), clients, customers, parents, and individuals.

17. The non-transitory computer readable medium of claim 15, wherein the plurality of donors comprises one or more patients of the plurality of patients.

18. The non-transitory computer readable medium of claim 15, further comprising instructions, that when read by the processor, cause the processor to perform:
determining if the outstanding medical fee is less than the first amount of resources;
in response to a determination that the outstanding medical fee is less than the first amount of resources, disbursing the outstanding medical fee to the third account from the first account, wherein the disbursement is performed using the first amount of resources; and
storing a surplus amount of resources as the second amount of surplus resources in the first account based on a determination that the outstanding medical fee is less than the first amount of resources, wherein the surplus amount of resources comprises the difference between the outstanding medical fee and the first amount of resources.

19. The non-transitory computer readable medium of claim 15, further comprising instructions, that when read by the processor, cause the processor to perform:
determining if the outstanding medical fee is greater than the first amount of resources but less than the sum of the first amount of resources and the second amount of surplus resources;
in response to a determination that the outstanding medical fee is greater than the first amount of resources but less than the sum of the first amount of resources and the second amount of surplus resources, disbursing the outstanding medical fee to the third account from the first account, wherein the disbursement is performed using the first amount of resources and the second amount of surplus resources.

20. The non-transitory computer readable medium of claim 15, wherein the first amount of resources is received in the first account at a periodic frequency.
